(19) United States
(12) Patent Application Publication
(10) Pub. No.: US 2023/0220515 A1
(43) Pub. Date: Jul. 13, 2023

(54) OBTAINING VALUABLE SOLIDS AND COMBUSTIBLE GAS FROM ALUMINUM REMELTING WASTE

(71) Applicant: Hydrova Inc., San Diego, CA (US)

(72) Inventors: Julian Tobias DAVIS, Fallbrook, CA (US); Rostam Matthew REIFSCHNEIDER, Rancho Santa Fe, CA (US)

(73) Assignee: Hydrova Inc., San Diego, CA (US)

(21) Appl. No.: 17/930,678

(22) Filed: Sep. 8, 2022

Related U.S. Application Data
(60) Provisional application No. 63/242,664, filed on Sep. 10, 2021.

(51) Int. Cl. C22B 21/00

(52) U.S. Cl. CPC C22B 21/0023

(57) ABSTRACT

Methods for obtaining solid products and combustible gas using aluminum waste are disclosed. In some embodiments, a method for obtaining solid products and combustible gas using aluminum waste may comprise: obtaining a reactive mass, the reactive mass comprising aluminum remelting waste or a derivative thereof; applying a solvent to the reactive mass to generate a solution and a first solid product; separating the solution from the first solid product; applying a reactant to at least a portion of the first solid product to initiate a reaction, the reactant being different from the solvent, the reaction generating a combustible gas and a second solid product; and separating the reactant from the second solid product.

### CROSS-REFERENCE TO RELATED APPLICATION

This application claims the benefit of U.S. Provisional Patent Application No. 63/242,664, filed Sep. 10, 2021, which is incorporated by reference herein in its entirety.

### FIELD OF THE DISCLOSURE

This disclosure relates to methods for processing aluminum remelting waste to obtain valuable products. Specifically, this disclosure relates to environmentally friendly methods for processing aluminum remelting waste to obtain valuable products such as hydrogen gas, aluminum, metal oxides, and salt.

### BACKGROUND

Drosses and salt cake are waste byproducts produced in large quantities by the aluminum industry every year. Aluminum dross is produced in primary aluminum smelting and secondary aluminum production (aluminum recycling) when molten metal comes into contact with air. This produces a mixture of elemental metal and metal oxides, along with other non-metallic materials, such as salts, that may have been added to the melt. Salt cake is produced when aluminum dross is further processed to recover the elemental metal trapped in the dross. After this processing is done, salt cake will still contain a small percentage of metal along with larger quantities of metal oxides and salt, as well as other elements and compounds. Aluminum dross is sometimes directly landfilled and salt cake is almost always landfilled, which creates a large environmental burden. This waste contains individual substances which each have value in industry. However, these substances can cause harmful chemical reactions when landfilled together, which can make the waste hazardous.

Accordingly, there is a need for methods that can process this waste to obtain valuable products. Further, there is a need for these methods to lower the environmental burden of this waste by, for example, reducing the amount of waste sent to landfill or reducing its hazardous impact.

### SUMMARY

The following description presents a simplified summary in order to provide a basic understanding of some aspects described herein. This summary is not an extensive overview of the claimed subject matter. It is intended to neither identify key or critical elements of the claimed subject matter nor delineate the scope thereof.

In some embodiments, a method for obtaining solid products and combustible gas may comprise: obtaining a reactive mass, the reactive mass comprising aluminum remelting waste or a derivative thereof; applying a solvent to the reactive mass to generate a solution and a first solid product; separating the solution from the first solid product; applying a reactant to at least a portion of the first solid product to initiate a reaction, the reactant being different from the solvent, the reaction generating a combustible gas and a second solid product; and separating the reactant from the second solid product. In some embodiments, applying the solvent to the reactive mass may generate a quantity of combustible gas that is less than half of a quantity of combustible gas generated in the reaction initiated by applying the reactant to the first solid product. In some embodiments, sodium chloride (NaCl) and potassium chloride (KCl) contained in the reactive mass and may be dissolved into the solvent to generate the solution. In some embodiments, the NaCl and KCl may be separated from the solution after the solution is separated from the first solid product. In some embodiments the second solid product may include an aluminum-oxide based material with an aluminum oxide content greater than 40 percent. In some embodiments, the solvent may comprise water. In some embodiments, the reactant may comprise an alkaline solution. In some embodiments the alkaline solution may comprise at least one of sodium hydroxide (NaOH) and potassium hydroxide (KOH). In some embodiments, applying the solvent to the reactive mass may generate an initial reaction, the first solid product comprising a reaction product from the initial reaction. In some embodiments, the method may further comprise separating one or more remaining salts from the second solid product. In some embodiments, applying the solvent to the reactive mass may be performed by receiving the reactive mass and the solvent in a reaction chamber; and applying the reactant to the first solid product may be performed by receiving the reactant in the reaction chamber.

In some embodiments, a method for obtaining solid products and combustible gas may comprise: obtaining a reactive mass, the reactive mass comprising aluminum remelting waste or a derivative thereof; applying a reactant to the reactive mass to initiate a reaction, the reaction generating solid products and a combustible gas of an amount greater than 0.05 grams of combustible gas per gram of metallic aluminum in the reactive mass; and capturing the combustible gas for use as an energy source.

In some embodiments, a system for recycling aluminum remelting waste may comprise: a reaction chamber comprising an enclosure and an internal volume configured to receive reactants; a solid liquid separator; a processing unit comprising one or more processors; and a memory storing computer-executable instructions, wherein the system is configured to: receive, in the reaction chamber, a reactive mass, the reactive mass comprising aluminum remelting waste or a derivative thereof; receive, in the reaction chamber, a solvent configured to generate a solution and a first solid product; separate, using the separator, the solution from the first solid product; apply a reactant to at least a portion of the first solid product to initiate a reaction, the reactant being different from the solvent, the reaction generating a combustible gas and a second solid product; and separate the reactant from the second solid product. In some embodiments, the system may be configured so that the separation of the first solid product from the solution and second solid product from the reactant is performed using the same separator at different points in time.

Further variations encompassed within the systems and methods are described in the detailed description of the invention below.

### BRIEF DESCRIPTION OF THE DRAWINGS

The accompanying drawings, which are incorporated herein and form part of the specification, illustrate various, non-limiting embodiments of the present invention. In the drawings, like reference numbers indicate identical or functionally similar elements.

FIG. 1 illustrates an exemplary method for obtaining solid products and combustible gas.

FIG. 2 illustrates an exemplary method for obtaining solid products and combustible gas.

FIG. 3 depicts an exemplary embodiment of a reactor.

FIG. 4A depicts aluminum dross residues which have had over 50% of the aluminum content removed.

FIG. 4B depicts aluminum dross.

FIG. 5 depicts an exemplary embodiment of a container to house combustible gas.

FIG. 6 depicts an exemplary embodiment of a system for recycling aluminum remelting waste.

FIG. 7 depicts an exemplary embodiment of a computer system.

### DETAILED DESCRIPTION

While aspects of the subject matter of the present disclosure may be embodied in a variety of forms, the following description and accompanying drawings are merely intended to disclose some of these forms as specific examples of the subject matter. Accordingly, the subject matter of this disclosure is not intended to be limited to the forms or embodiments so described and illustrated. For the purposes of this disclosure, the term “combustible gas” refers to a gas that may be combusted to release energy, e.g., for use as fuel. Exemplary combustible gases discussed herein may include hydrogen and other gases such as methane and ammonia. The term “trace gas” or “trace compound” refers to a gas or compound in a mixture that constitutes a minority portion of the total mass of the mixture.

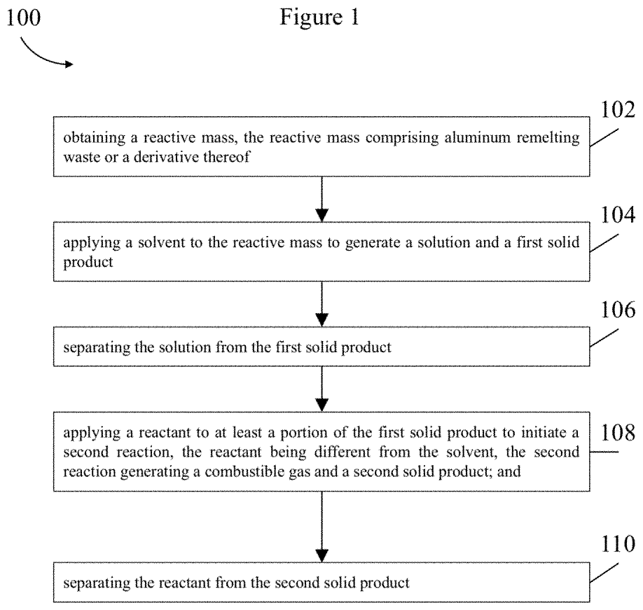

FIG. 1 illustrates an exemplary method 100 for obtaining solid products and a combustible gas. In step 102, a reactive mass may be obtained. In some embodiments, the reactive mass may include aluminum remelting waste. As used herein, the term “aluminum remelting waste” refers to products that result from primary aluminum smelting and/or remelting aluminum (including, for example, for aluminum recycling). Examples of aluminum remelting waste include but are not limited to the following or derivatives thereof: aluminum dross, dross, dross residues, white dross, grey dross, black dross, bag house dust, salt cake, and salt slag. In some embodiments, the reactive mass may be pretreated for particle size reduction by crushing or milling. In some embodiments, a portion of the metal aluminum content of the reactive mass may be removed before step 102. In some embodiments, over 50% of the metallic aluminum content of the reactive mass may be removed before step 102. In some embodiments, the reactive mass may be pretreated for aluminum removal through crushing, grinding, milling, sieving, or melting.

In step 104, a solvent may be applied to the reactive mass to generate a solution and a first solid product. The solution may include any amount of dissolved material, including trace amounts. The dissolved material may include, for example, sodium chloride or potassium chloride. In some embodiments, the solvent may initiate a first reaction with the reactive mass. In some embodiments, the first reaction may generate a first combustible gas and a first solid product. The first solid product may include, for example, aluminum oxide and other compounds. In some embodiments, the other compounds may contain one or more of: aluminum, arsenic, cadmium, chromium, copper, nickel, iron, titanium, tin, manganese, lead, selenium, magnesium, zinc, potassium, sodium, silicon, calcium, titanium, iron, sulfur, oxides of listed metals, aluminum carbide, aluminum nitride, magnesium chloride, calcium chloride, sodium chloride, and potassium chloride. In some embodiments, the solvent may be or include water. In some embodiments, the water may be cold water having a temperature between 0 C and 50 C. In other embodiments, the water may be hot water having a temperature between 50 C and 100 C. In some embodiments, the solution may be or include water vapor. In some embodiments the solvent or solution may be or include a salt water solution or brine. In some embodiments, the solvent or solution may be or include an alkaline solution. In some embodiments, the solvent or solution may be a first reactant configured to cause the reactive mass to release a first combustible gas that is preferably less than 50% hydrogen by molecular concentration. Less preferably, the first reactant may be configured to cause the reactive mass to release a first combustible gas that is more than 50% hydrogen by molecular concentration. In some embodiments, the first combustible gas may contain less than 40%, 30%, 20%, or 10% hydrogen by molecular concentration. In some embodiments, the solvent may be a substance in which salt is soluble. In some embodiments, the solvent may be configured to separate salt from the reactive mass. In some embodiments, the solvent may be configured to separate salt from the reactive mass without reacting with aluminum in the reactive mass. In some embodiments, the solvent may be configured to separate salt from the reactive mass without reacting with a substantial amount of aluminum in the reactive mass. In some embodiments, the solvent may comprise one or more of water, sodium hydroxide solution, sodium hydroxide solution of concentration between 0 M and 2 M, potassium hydroxide solution, potassium hydroxide solution of concentration between 0 M and 2 M, ethanol, glycerol, anhydrous ethanol, anhydrous glycerol, methanol, propylene glycol, ammonia, formamide, formic acid, or mixtures thereof.

In some embodiments, the reactant may include water and step 104 may further include applying a eutectic alloy to the reactive mass. The eutectic alloy may include one or more of gallium, indium, tin, and bismuth. In some embodiments, any of the eutectic alloys or methods of preparing aluminum to be reacted with water described in U.S. Nonprovisional patent application Ser. No. 17/571,157 and U.S. Provisional Patent Application No. 63/135,163 (the entirety of which are hereby incorporated by reference) may be used. In some embodiments, the reactant may comprise water and the method may further include milling the reactive mass. In some embodiments, the reactant may comprise water and the method may further include milling the reactive mass with the addition of a milling additive. In some embodiments, a milling additive may include salts such as sodium chloride and potassium chloride. In some embodiments, any of the milling additives or methods of preparing aluminum to be reacted with water described in U.S. Nonprovisional patent application Ser. No. 17/586,528 and U.S. Provisional Patent Application No. 63/143,691 (the entirety of which are hereby incorporated by reference) may be used.

In step 106, the solution may be separated from the first solid products. In some embodiments, the solution may be separated from the reactive mass once salts in the reactive mass have dissolved into the solvent. In some embodiments, the separation may be performed using filtration, vacuum filtration, rotary vacuum filtration, centrifugation, or gravity separation. In some embodiments, the solvent may be configured to react with, decompose, or remove nitrides in the reactive mass. In some embodiments, the solvent may be configured to react with, decompose, or remove carbides in the reactive mass. The first reactant may preferably be reclaimed for future use. In some embodiments, the first reactant may be reclaimed and used for a reaction with a second reactive mass comprising aluminum remelting waste or a derivative thereof. In some embodiments, the reactant may be reclaimed and reused as many times as desired. In some embodiments, more than 70%, 80%, 90%, or 95% of the reactant may be reclaimed from the reactions described herein.

In some embodiments, salt dissolved into the solvent may be recovered by separating salt from the solution. In some embodiments, this separation step may comprise one or more of evaporation, solar evaporation, vacuum pan evaporation, reverse-osmosis, steam driven crystallization, thermocompression driven crystallization, vapor compression crystallization, or zero-liquid discharge crystallization.

In some embodiments, the salts recovered from the reactive mass may be used as a milling additive to prepare aluminum recovered from the reactive mass for reaction with water. In some embodiments, this preparation may create composite aluminum-salt particles.

In some embodiments, the salts recovered from the reactive mass may be used in one or more of: rotary salt furnace, dross processing, aluminum recycling, aluminum recovery, aluminum remelting, and aluminum smelting.

In step 108, a reactant may be applied to the first solid products. In some embodiments, the reactant may be different from the solvent. In some embodiments, the reactant may initiate a reaction. References herein to a “second reaction” refer to this reaction which is initiated by introducing the reactant. Although the term “second reaction” is used, this “second reaction” may in some cases be the first reaction performed, such as, for example, when the solvent application step 104 is omitted or when the solvent used does not react with the reactive mass. In some embodiments, the second reaction may generate a combustible gas. References herein to a second reaction refer to this reaction which is initiated by introducing the reactant. Although the term “second combustible gas” is used, this “second combustible gas” may in some cases be the first combustible gas obtained, such as, for example, when the solvent application step 104 does not produce a detectable or useful amount of combustible gas. Applying the reactant to the first solid products may initiate the second reaction, which may produce the second combustible gas and a second solid product. The second solid product may include the same compounds contained in the first solid product, but the second solid product may generally include a smaller percentage of metallic aluminum than does the first solid product.

In some embodiments, the reactant may be or include an alkaline solution. In some embodiments, the alkaline solution may be or include one or more of cold sodium hydroxide solution of temperature between 0 C and 50 C and concentration between 0 M and 2 M, hot sodium hydroxide solution of temperature between 50 C and 100 C and concentration between 0 M and 2 M, cold potassium hydroxide solution of temperature between 0 C and 50 C and concentration between 0 M and 2 M, and hot potassium hydroxide solution of temperature between 50 C and 100 C and concentration between 0 M and 2 M. In some embodiments, the reactant may be recovered and reused to initiate another reaction.

The reactant may preferably be configured to cause the reactive mass to release a second combustible gas that is more than 50% hydrogen by molecular concentration. Less preferably, the reactant may be configured to cause the reactive mass to release a second combustible gas that is less than 50% hydrogen by molecular concentration. The second combustible gas may be more than 99%, 98%, 97%, 95%, 90%, 80%, 70%, 60%, or 40% hydrogen by molecular concentration.

In some embodiments, the reactant may include water and step 108 may further include applying a eutectic alloy to the reactive mass. The eutectic alloy may include one or more of gallium, indium, tin, and bismuth. In some embodiments, any of the eutectic alloys or methods of preparing aluminum to be reacted with water described in U.S. Nonprovisional patent application Ser. No. 17/571,157 and U.S. Provisional Patent Application No. 63/135,163 may be used. In some embodiments, the reactant may comprise water and the method may further include milling the reactive mass. In some embodiments, the reactant may comprise water and the method may further include milling the reactive mass with the addition of a milling additive. In some embodiments, milling additive may include salts such as sodium chloride and potassium chloride. In some embodiments, any of the milling additives or methods of preparing aluminum to be reacted with water described in U.S. Nonprovisional patent application Ser. No. 17/586,528 and U.S. Provisional Patent Application No. 63/143,691 may be used.

In step 110, the reactant may be separated from the second solid product. In some embodiments, the second solid product may be recovered after the second reaction. In some embodiments, the second solid products may be recovered through filtration, vacuum filtration, rotary vacuum filtration, centrifugation, or gravity separation. In some embodiments, solids may be recovered from the reactive mass after a solvent is applied to the reactive mass. By recovering the second solid product, the components of the second solid product may be reused. In some embodiments, the second solid products may be used as cement additives or refractory material. In some embodiments, the second solid product may be used for production of calcium aluminate cement.

In some embodiments of method 100, the first combustible gas and/or second combustible gas may be captured. In some embodiments, the combustible gas may be captured in a container. In some embodiments, the method may further include preparing a combustible gas for use after it is captured. In some embodiments, the combustible gas may include hydrogen gas and methane gas, and the step of preparing the combustible gas for use may include at least one of: (i) separating the hydrogen gas from the methane gas; and (ii) separating the hydrogen gas and methane gas, together, from other substances. In some embodiments, the combustible gas may include hydrogen gas and ammonia gas, and the step of preparing the combustible gas for use may include at least one of: (i) separating the hydrogen gas from the ammonia gas; and (ii) separating the hydrogen gas and ammonia gas, together, from other substances. In some embodiments, the combustible gas may include hydrogen gas, methane gas, and ammonia gas, and the step of preparing the combustible gas for use may include at least one of: (i) separating the hydrogen gas from the methane gas and the ammonia gas; (ii) separating the methane gas from the hydrogen gas and the ammonia gas, (iii) separating the ammonia gas from the hydrogen gas and the methane gas, and (iv) separating the hydrogen gas, methane gas, and ammonia gas, together, from other substances. In some embodiments, the step of preparing the combustible gas for use may further include converting the methane to hydrogen. In some embodiments, steam methane reforming or methane pyrolysis may be used to convert methane to hydrogen. In some embodiments, the step of preparing the combustible gas for use may further include converting the ammonia to hydrogen. In some embodiments, the separation of gases may comprise membrane separation, pressure swing absorption, molecular sieve, or electrochemical separation.

In the previous example embodiments, water or water vapor may be used to react with aluminum nitride in the reactive mass in order to generate a combustible gas containing at least 50% ammonia. In some embodiments, the water or water vapor may be at a temperature above 120-150 C. For example, this reaction may occur before a different reaction occurs that produces a combustible gas containing at least 50% hydrogen.

In an example embodiment, a reactive mass may be obtained, the reactive mass comprising aluminum remelting waste or a derivative thereof. An anhydrous solvent may be added to the reactive mass, which may dissolve salt and remove that salt from the reactive mass. This anhydrous solvent may include ethanol, glycerol, methanol, propylene glycol, ammonia, formamide, formic acid, or mixtures thereof. This anhydrous solvent may prevent substances in the reactive mass that can react with water from reacting (for example, aluminum carbide, aluminum nitride, or aluminum). Additionally, solids may be recovered from the reactive mass after the solvent is added.

In some embodiments, the reactive mass may contain zinc dross, tin dross, lead dross, silver dross, steel slag, or derivatives thereof. In some embodiments, the reactive mass may contain byproducts of metal smelting, metal remelting, or metal manufacturing.

In some embodiments the reactive mass may contain aluminum metal, aluminum oxide and other substances. In some embodiments the reactive mass may have a similar composition to aluminum remelting waste, while not itself deriving from the aluminum remelting process. In some embodiments, the reactive mass may contain aluminum scrap or machining chips.

In some embodiments, heat generated from exothermic reactions with the reactive mass may be used for heat in other parts of the process. An example exothermic reaction is the reaction between aluminum and water. In some embodiments, the heat generated can be used to produce above-room-temperature water. In some embodiments, the heat generated can be used to partially or fully evaporate the solvent from salt in order to obtain solid salt.

In some embodiments, the reactive mass comprising aluminum remelting waste or a derivative thereof can be mechanically processed before being added to a reactant. For example, the reactive mass may be ball milled, grinded, crushed, or sieved to prepare.

In some embodiments, mechanical processing of the reactive mass may include adding salt or aluminum oxide as a nano miller increase the reactivity of the aluminum metal content inside the reactive mass. For example, salt or aluminum oxide could be added to the reactive mass in a ball mill to nano-mill the aluminum metal in order to create larger surface area per volume of aluminum metal. This larger surface area may increase reactivity with water and thus hydrogen generation.

In some embodiments, aluminum metal may refer to metal alloys that include aluminum.

In some embodiments, a portion or the entirety of the aluminum metal in the reactive mass may be recovered before or after further processing steps occur. The aluminum metal may be recovered by one or more of the following processes: rotary salt furnace, hot picking, hot dross pressing, cold dross pressing, cold mechanical processing, floor cooling, stirring, shaking, inert gas dross cooling, cast steel dross pans, sieving, or ball milling.

In some embodiments, the reactant may comprise an alkaline solution. For example, the alkaline solution may include water and sodium hydroxide or potassium hydroxide. This may produce hydrogen due to the aluminum metal in the reactive mass reacting with the alkaline solution. The products of the reaction may include one or more of the following: aluminum hydroxide, aluminum oxide, hydrogen, water, sodium aluminate, sodium hydroxide, potassium aluminate, potassium hydroxide, and other compounds containing one or more of the elements: sodium, potassium, hydrogen, oxygen, aluminum. The sodium hydroxide or potassium hydroxide may be reused for reactions with a second reactive mass to produce a second quantity of hydrogen. The sodium aluminate or potassium aluminate may be used to produce sodium hydroxide that can be used for reactions with a second reactive mass as well.

In some embodiments, aluminum metal in the reactive mass may react with water to produce hydrogen gas and aluminum oxide. In some embodiments, aluminum metal in the reactive mass may react with water to produce hydrogen gas and aluminum hydroxide. Aluminum hydroxide may be heated or calcinated to produce aluminum oxide. For example, aluminum hydroxide may be heated at above 800 C to produce aluminum oxide.

In some embodiments, one or more of aluminum oxide, aluminum carbide and aluminum nitride may be maintained in the reactive mass throughout one or multiple reaction steps. These compounds may, for example, be maintained in the reactive mass in order to be used as a cement additive or refractory material. For example, aluminum oxide may be maintained in the reactive mass by avoiding the introduction of substances that react with aluminum oxide, one example substance being hydrochloric acid. For example, aluminum carbide may be maintained in the reactive mass by avoiding the introduction of substances that react with aluminum carbide, one example substance being water. For example, aluminum nitride may be maintained in the reactive mass by avoiding the introduction of substances that react with aluminum nitride, one example substance being water with a temperature above 120-150 C.

In some embodiments, a reactant may be added to the reactive mass that decreases the hazardous potential of the reactive mass. For example, a reactive mass containing aluminum remelting waste may be considered hazardous due to its ability to generate combustible gases such as hydrogen, ammonia, and methane when in landfill. By adding water, as an example reactant, the reactive mass may react with the reactant to produce these combustible gases. This reaction may prevent further reactions from occurring in landfill, thus reducing the reactivity and hazardous potential of the reactive mass.

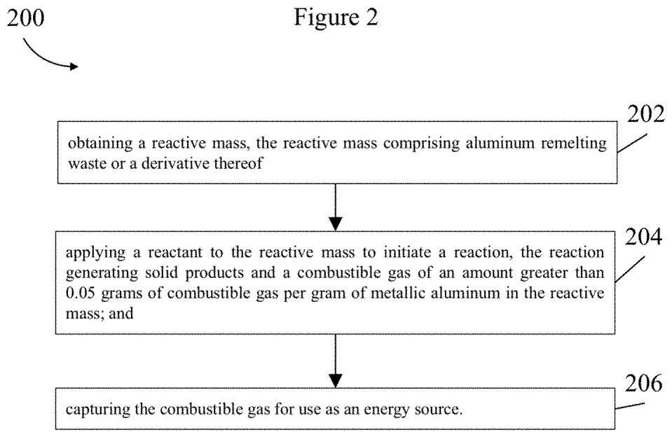

FIG. 2 illustrates an exemplary method 200 for obtaining solid products and combustible gas. In step 202, a reactive mass containing aluminum remelting waste or a derivative thereof may be obtained. In step 204, a reactant may be applied to the reactive mass to initiate a reaction. The reaction may generate solid products and a combustible gas. The combustible gas generated may preferably be of an amount greater than 0.05 grams per gram of metallic aluminum in the reactive mass. In other embodiments, the combustible gas generated may be of an amount greater than 0.04 or 0.03 grams per gram of metallic aluminum in the reactive mass. In step 206, the combustible gas may be captured and products may be recovered from the solid products. In some embodiments, the reactive mass may be configured to encourage the reaction between aluminum in the reactive mass and water. In some embodiments, the reactive mass may be prepared by reducing the particle size and increasing the surface area of the reactive mass. In some embodiments, any of the milling additives or methods of preparing aluminum to be reacted with water described in U.S. Nonprovisional patent application Ser. No. 17/586,528 and U.S. Provisional Patent Application No. 63/143,691 may be used. Method 200 may comprise any of the processes, methods, or reactions described herein.

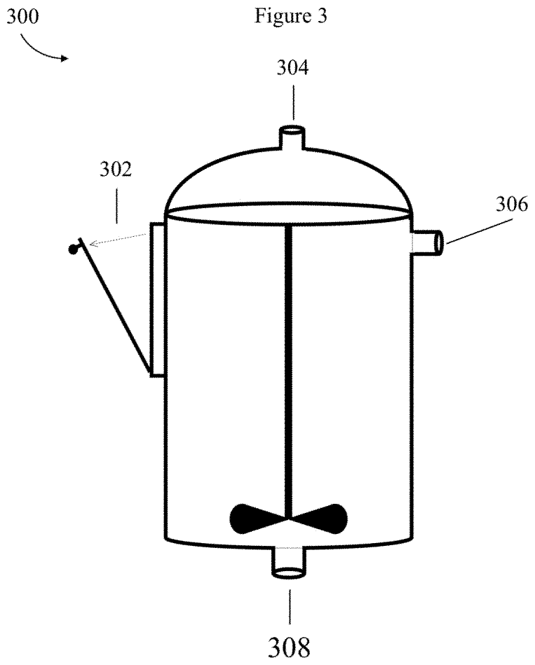

FIG. 3 depicts an exemplary embodiment of a reactor 300. In some embodiments, step 104 from FIG. 1 may take place inside the reactor. In some embodiments, step 108 from FIG. 1 may take place inside the reactor. In some embodiments, step 204 from FIG. 2 may take place inside the reactor. In some embodiments, the reactive mass may be introduced to the reactor through inlet hopper 302. In some embodiments, the solvent and/or reactant may be introduced to the reactor through valve 306. In some embodiments, any of the following may be generated in the reactor: a solution, a combustible gas, heat, and reaction byproducts. In some embodiments, the reaction byproducts may exit the reactor through outlet drain 308. In some embodiments, a combustible gas may exit the reactor through collector 304. In some embodiments, step 106 from FIG. 1 may take place as the combustible gas exits the reactor. In some embodiments, the temperature inside the reactor may be maintained between 50 C and 100 C. In some embodiments, the heat generated by the reaction may be used to maintain an elevated temperature in the reactor. In some embodiments, the pressure inside the reactor may be maintained above 1 atm. In some embodiments, the gas generated by the reaction may be used to maintain pressure. In some embodiments, reactor 300 may be used to conduct any of the processes, methods, or reactions described herein.

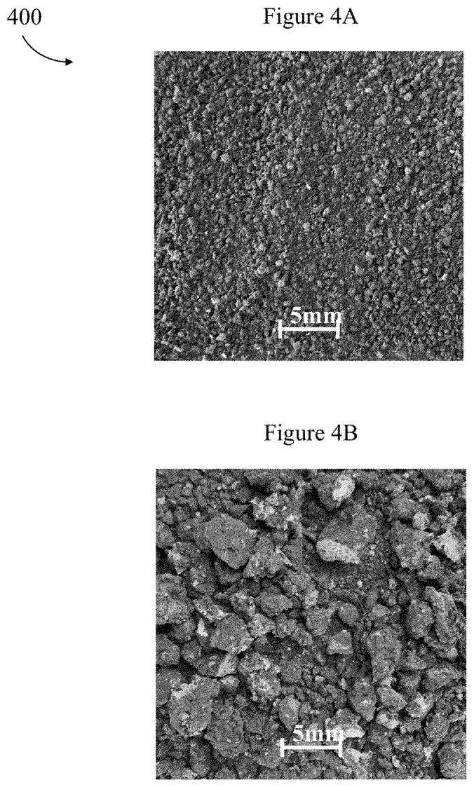

FIGS. 4A and 4B depict exemplary embodiments of aluminum remelting waste. FIG. 4A depicts aluminum dross residues which have had over 50% of the aluminum content removed. FIG. 4B depicts aluminum dross.

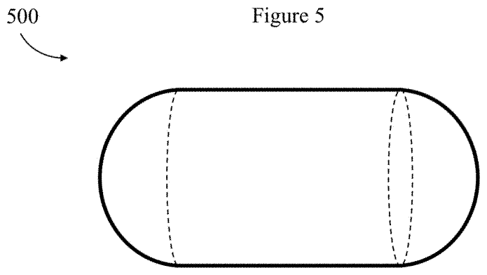

FIG. 5 depicts an exemplary embodiment of a container 500 housing a combustible gas. The combustible gas may be obtained using any of the methods described herein. In some embodiments, the gas may be compressed. In some embodiments, the gas may be liquefied. In some embodiments, the gas may be used as fuel, or blended with other fuels such as natural gas. In some embodiments, fuel deriving from the gas or gas blend may be combusted for heat or energy. In some embodiments, the gas may be introduced to a fuel cell to produce electrical power. In some embodiments, the fuel cell may include a proton-exchange membrane fuel cell, also known as a polymer electrolyte membrane fuel cell. In some embodiments, the fuel cell may include a solid oxide fuel cell. In some embodiments, the fuel cell may include an alkaline fuel cell. In some embodiments, the combustible gas may include hydrogen. In some embodiments, the gas may be combustible gas may be purified to be used in the fuel cell.

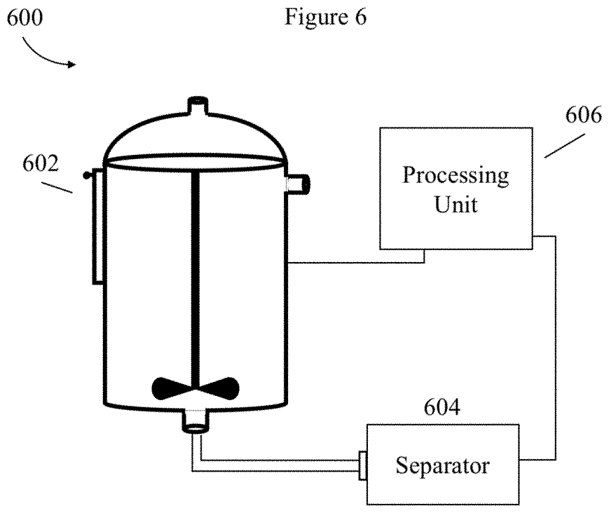

FIG. 6 depicts an exemplary system 600 for recycling aluminum remelting waste. A reaction chamber 602 may comprise an enclosure and an internal volume configured to receive reactants. A separator 604 may comprise a solid-liquid separator. A processing unit 606 may comprise one or more processors and may contain a memory storing computer-executable instructions. The system may be configured to: receive, in the reaction chamber, a reactive mass, the reactive mass comprising aluminum remelting waste or a derivative thereof. The system may further be configured to receive, in the reaction chamber, a solvent configured to generate any of the following: a solution, a first reaction generating a first combustible gas, and a first solid product. The system may further be configured to separate, using separator 604, the solvent from the first solid product. The system may be configured to apply a reactant to at least a portion of the first solid product to initiate a reaction, the reactant being different from the solvent, the reaction generating a combustible gas and a second solid product. The system may further be configured to separate the reactant from the second solid product. In some embodiments, system 600 may be used to conduct any of the processes, methods, or reactions described herein.

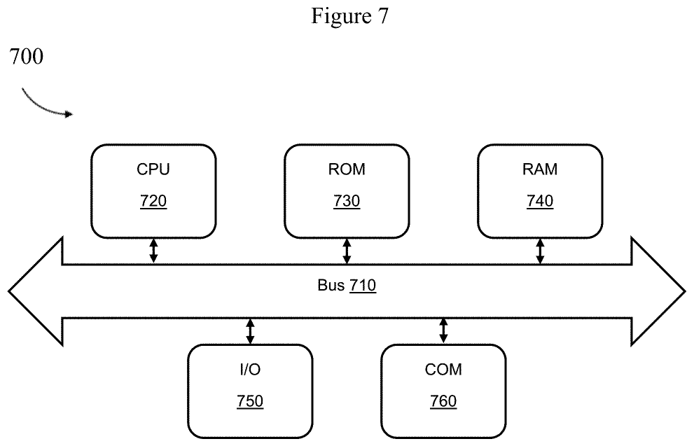

FIG. 7 depicts an example of a computer system that may be incorporated into or used to control a reaction system such as that described above with respect to FIG. 6. FIG. 7 is a simplified functional block diagram of a computer that may be configured to execute techniques described herein, according to exemplary cases of the present disclosure. Specifically, the computer (or “platform” as it may not be a single physical computer infrastructure) may include a data communication interface 760 for packet data communication. The platform may also include a central processing unit (“CPU”) 720, in the form of one or more processors, for executing program instructions. The platform may include an internal communication bus 710, and the platform may also include a program storage and/or a data storage for various data files to be processed and/or communicated by the platform such as ROM 730 and RAM 740, although the system 700 may receive programming and data via network communications. The system 700 also may include input and output ports 750 to connect with input and output devices such as keyboards, mice, touchscreens, monitors, displays, etc. Of course, the various system functions may be implemented in a distributed fashion on a number of similar platforms, to distribute the processing load. Alternatively, the systems may be implemented by appropriate programming of one computer hardware platform.

The general discussion of this disclosure provides a brief, general description of a suitable computing environment in which the present disclosure may be implemented. In some cases, any of the disclosed systems, methods, and/or graphical user interfaces may be executed by or implemented by a computing system consistent with or similar to that depicted and/or explained in this disclosure. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, multi-processor systems, microprocessor-based or programmable consumer electronics, network PCs, mini-computers, mainframe computers, and the like. I

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure may also be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

### EXAMPLE

An example embodiment of the method for obtaining combustible gas using waste aluminum that demonstrates the commercial value of the technology to SAPs in an on-site model is outlined below in 5 steps: aluminum recovery, salt recovery, reaction, oxide recovery, and hydrogen recovery.

### Aluminum Recovery

The aluminum remelting waste first has its aluminum content recovered to the same degree as is standard in the secondary aluminum processing industry. The rate of aluminum recovery is the most critical aspect of aluminum remelting waste processing to aluminum processors. The aluminum recovery step may be performed by a secondary aluminum processor (SAP) or by a dross processor before entering any of the processes described by FIG. 1 and FIG. 2, or may be performed during the processes described by FIG. 1 and FIG. 2.

### Salt Recovery

The salt content of the aluminum remelting waste may be leached out with a solvent because the salt provides value to aluminum processors as flux. Reusing recovered salt for flux creates an opportunity to create value through the recovery on site, avoiding the need for transportation. The salt content is leached out with a solvent that encourages the decomposition of aluminum carbide and aluminum nitride, which converts the aluminum carbide and aluminum nitride to aluminum oxide, and releases methane gas, and ammonia gas. This allows for the following reaction step to generate pure hydrogen gas by purging the unwanted gases prior to the reaction. The salt content is leached out with a solvent that does not encourage the aluminum-water reaction, however, so that the salt content can be removed prior to the reaction. This allows for the alkaline solution used in the reaction step to be recovered and reused without becoming overly concentrated with salt. An exemplary solvent with these properties is water. The salt brine and the solid aluminum remelting waste may be separated. This separation step may be performed using standard solid-liquid separation techniques. The gas generated in the salt recovery step has been shown to contain up to 26.7% methane by methods of gas chromatography. Generally, the gas may contain between 0% and 99% methane.

### Reaction

The solids recovered from the previous step are introduced to an alkaline solution which encourages the aluminum-water reaction. The aluminum-water reaction proceeds to completion generating hydrogen gas and heat, converting all or nearly all of the remaining aluminum metal in the material to aluminum oxide. The heat from the reaction helps maintain the reaction chamber at an elevated temperature. The alkaline solution can be recovered and reused for future reactions. The gas generated by the reaction step has been shown to contain 99.9% hydrogen and 0.1% methane by methods of gas chromatography. Generally, the gas may contain between 75% and 99.999% hydrogen and between 0% and 2% methane.

### Oxide Recovery

The alkaline solution is separated from the remaining solids. This may be performed using standard solid-liquid separation techniques. The alkaline solution is recirculated back into the reaction chamber and reused. The aluminum oxide that remains the solid byproducts is dried and sold as a cement additive or refractory material, enabling a zero-waste solution to aluminum dross and salt cake.

The hydrogen gas generated by the reaction is captured by a hood. The gas may be used to power either the aluminum recovery, salt recovery, oxide recovery, or aluminum manufacturing process that produced the dross or salt cake. The gas may be blended into the aluminum processor's natural gas furnaces to lower costs and emissions, presenting an opportunity to create value through the hydrogen generation on site, avoiding the need for transportation.

### Results:

| | | | Salt | | | Gas |
|---|---|---|---|---|---|---|
| Input | Step | Solvent | Recovered | Reactant | Temperature | Composition |
| Black | Salt Recovery | Water | yes | Water | 20 C. | H₂: 73.2% |
| Dross | | | | | | CH₄: 26.7% |
| Products | Reaction | None | n/a | 0.75M | 20 C. | H₂: 99.9% |
| of Salt | | | | NaOH | | CH₄: 0.1% |
| Recovery | | | | | | |
| Step | | | | | | |

### NUMBERED EMBODIMENTS

Examples of methods and systems in accordance with the present disclosure are provided below. These examples are non-limiting and may be combined with, for example, any of the method steps described above with respect to FIGS. 1 and 2.

Embodiment 1. A method for obtaining solid products and combustible gas, the method comprising:

obtaining a reactive mass, the reactive mass comprising aluminum remelting waste or a derivative thereof;

applying a solvent to the reactive mass to generate a solution and a first solid product;

separating the solution from the first solid product;

applying a reactant to at least a portion of the first solid product to initiate a reaction, the reactant being different from the solvent, the reaction generating a combustible gas and a second solid product; and

separating the reactant from the second solid product.

Embodiment 2. The method of Embodiment 1, wherein applying the solvent to the reactive mass generates a quantity of combustible gas than is less than half of a quantity of combustible gas generated in the reaction initiated by applying the reactant to the first solid product.
Embodiment 3. The method of any of Embodiments 1-2, wherein sodium chloride (NaCl) and potassium chloride (KCl) contained in the reactive mass and are dissolved into the solvent to generate the solution.
Embodiment 4. The method of Embodiment 3, further comprising separating the NaCl and KCl from the solution after the solution is separated from the first solid product.
Embodiment 5. The method of any of Embodiments 1-4, wherein the second solid product includes an aluminum-oxide based material with an aluminum oxide content greater than 40 percent.
Embodiment 6. The method of any of Embodiments 1-5, wherein the solvent comprises water.
Embodiment 7. The method of any of Embodiments 1-6, wherein the reactant comprises an alkaline solution.
Embodiment 8. The method of Embodiment 7, wherein the alkaline solution comprises at least one of sodium hydroxide (NaOH) and potassium hydroxide (KOH).
Embodiment 9. The method of any of Embodiments 1-8, wherein applying the solvent to the reactive mass generates an initial reaction, the first solid product comprising a reaction product from the initial reaction.
Embodiment 10. The method of any of Embodiments 1-9, wherein the method further comprises separating one or more remaining salts from the second solid product.
Embodiment 11. The method of any of Embodiments 1-10, wherein:

applying the solvent to the reactive mass is performed by receiving the reactive mass and the solvent in a reaction chamber; and

applying the reactant to the first solid product is performed by receiving the reactant in the reaction chamber.

Embodiment 12. A method for obtaining solid products and combustible gas, the method comprising:

obtaining a reactive mass, the reactive mass comprising aluminum remelting waste or a derivative thereof;

applying a reactant to the reactive mass to initiate a reaction, the reaction generating solid products and a combustible gas of an amount greater than 0.05 grams of combustible gas per gram of metallic aluminum in the reactive mass; and

capturing the combustible gas for use as an energy source.

Embodiment 13. The method of Embodiment 12, further combined with any of the features in any of Embodiments 2-11.
Embodiment 14. A system for recycling aluminum remelting waste, the system comprising:

a reaction chamber comprising an enclosure and an internal volume configured to receive reactants;

a solid liquid separator;

a processing unit comprising one or more processors; and

a memory storing computer-executable instructions, wherein the system is configured to:

receive, in the reaction chamber, a reactive mass, the reactive mass comprising aluminum remelting waste or a derivative thereof;

receive, in the reaction chamber, a solvent configured to generate a solution and a first solid product;

separate, using the separator, the solution from the first solid product;

apply a reactant to at least a portion of the first solid product to initiate a reaction, the reactant being different from the solvent, the reaction generating a combustible gas and a second solid product; and

separate the reactant from the second solid product.

Embodiment 15. The system of Embodiment 14, wherein the separation of the first solid product from the solution and second solid product from the reactant is performed using the same separator at different points in time.
Embodiment 16. The system of any of Embodiments 14-15, further combined with any of the features in any of Embodiments 2-11.

Other aspects of the disclosure will be apparent to those skilled in the art from consideration of the specification and practice of the invention disclosed herein. It is intended that the specification and examples be considered as exemplary only, with a true scope and spirit of the invention being indicated by the following claims.

1. A method for obtaining solid products and combustible gas, the method comprising:
obtaining a reactive mass, the reactive mass comprising aluminum remelting waste or a derivative thereof;
applying a solvent to the reactive mass to generate a solution and a first solid product;
separating the solution from the first solid product;
applying a reactant to at least a portion of the first solid product to initiate a reaction, the reactant being different from the solvent, the reaction generating a combustible gas and a second solid product; and
separating the reactant from the second solid product.

2. The method of claim 1, wherein applying the solvent to the reactive mass generates a quantity of combustible gas than is less than half of a quantity of combustible gas generated in the reaction initiated by applying the reactant to the first solid product.

3. The method of claim 1, wherein sodium chloride (NaCl) and potassium chloride (KCl) contained in the reactive mass and are dissolved into the solvent to generate the solution.

4. The method of claim 3, further comprising separating the NaCl and KCl from the solution after the solution is separated from the first solid product.

5. The method of claim 1, wherein the second solid product includes an aluminum-oxide based material with an aluminum oxide content greater than 40 percent.

6. The method of claim 1, wherein the solvent comprises water.

7. The method of claim 1, wherein the reactant comprises an alkaline solution.

8. The method of claim 7, wherein the alkaline solution comprises at least one of sodium hydroxide (NaOH) and potassium hydroxide (KOH).

9. The method of claim 1, wherein applying the solvent to the reactive mass generates an initial reaction, the first solid product comprising a reaction product from the initial reaction.

10. The method of claim 1, wherein the method further comprises separating one or more remaining salts from the second solid product.

11. The method of claim 1, wherein:
applying the solvent to the reactive mass is performed by receiving the reactive mass and the solvent in a reaction chamber; and
applying the reactant to the first solid product is performed by receiving the reactant in the reaction chamber.

12. A method for obtaining solid products and combustible gas, the method comprising:
obtaining a reactive mass, the reactive mass comprising aluminum remelting waste or a derivative thereof;
applying a reactant to the reactive mass to initiate a reaction, the reaction generating solid products and a combustible gas of an amount greater than 0.05 grams of combustible gas per gram of metallic aluminum in the reactive mass; and
capturing the combustible gas for use as an energy source.

13. A system for recycling aluminum remelting waste, the system comprising:
a reaction chamber comprising an enclosure and an internal volume configured to receive reactants;
a solid liquid separator;
a processing unit comprising one or more processors; and
a memory storing computer-executable instructions, wherein the system is configured to:
receive, in the reaction chamber, a reactive mass, the reactive mass comprising aluminum remelting waste or a derivative thereof;
receive, in the reaction chamber, a solvent configured to generate a solution and a first solid product;
separate, using the separator, the solution from the first solid product;
apply a reactant to at least a portion of the first solid product to initiate a reaction, the reactant being different from the solvent, the reaction generating a combustible gas and a second solid product; and
separate the reactant from the second solid product.

14. The system of claim 13, wherein the separation of the first solid product from the solution and second solid product from the reactant is performed using the same separator at different points in time.
